(19) United States
(12) Patent Application Publication
(10) Pub. No.: US 2014/0247958 A1
(43) Pub. Date: Sep. 4, 2014

(54) SOUND AMPLIFYING DEVICE AND ELECTRONIC PRODUCT USING THE SAME

(71) Applicant: CHIUN MAI COMMUNICATION SYSTEMS, INC., New Taipei (TW)

(72) Inventors: WEI-RUNG CHEN, New Taipei (TW); KUANG-HSIEN WANG, New Taipei (TW)

(73) Assignee: CHIUN MAI COMMUNICATION SYSTEMS, INC., New Taipei (TW)

(21) Appl. No.: 14/015,124

(22) Filed: Aug. 30, 2013

(30) Foreign Application Priority Data
Mar. 1, 2013 (TW) 102203759

(51) Int. Cl. H04R 1/02

(52) U.S. Cl. CPC H04R 1/02
USPC 381/387

(57) ABSTRACT

A sound amplifying device includes a base part and an amplifying part. The amplifying part is mounted on the base part. The amplifying part includes a reflecting wall and a bracket. The reflecting wall has a hollow semi-ellipse shape with a semi major axis and a minor axis. The bracket is mounted on the reflecting wall and has one end positioned on the semi major axis. An electronic product using the sound amplifying device includes the sound amplifying device and an electronic device removably mounted on the sound amplifying device. The sound amplifying device generates a maximum loudness effect.

### BACKGROUND

1. Technical Field

The exemplary disclosure generally relates to a sound amplifying device and an electronic product using the sound amplifying device.

2. Description of Related Art

Typically, a user has to insert an earphone plug into the audio port of the portable electronic device and then wears the earphone to hear the music from the electronic device. Alternatively, the user can utilize a loudspeaker built in the portable electronic device to play the music via the audio port. However, the sound quality and sound-amplifying effect of the built-in loud speaker of the portable device product may be low. Thus, some people like to use an external loudspeaker box to generate a better sound quality and loud-amplifying effect, which can be inconvenient since the external loudspeaker box is required to be electrically connected to a power supply.

Therefore, there is room for improvement within the art.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings like reference numerals designate corresponding parts throughout the several views.

FIG. 1 is a schematic view of an exemplary embodiment of a sound amplifying device.

FIG. 2 is a schematic view of an electronic product using the sound amplifying device of FIG. 1.

FIG. 3 is a cross-sectional view of the electronic product of FIG. 2 taken along line

### DETAILED DESCRIPTION

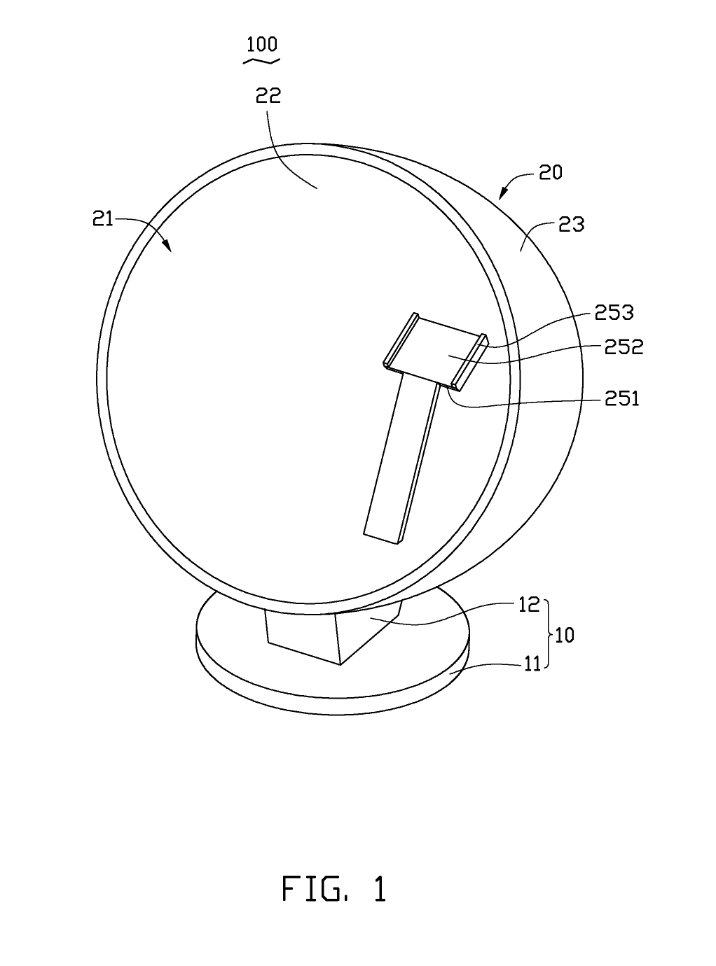

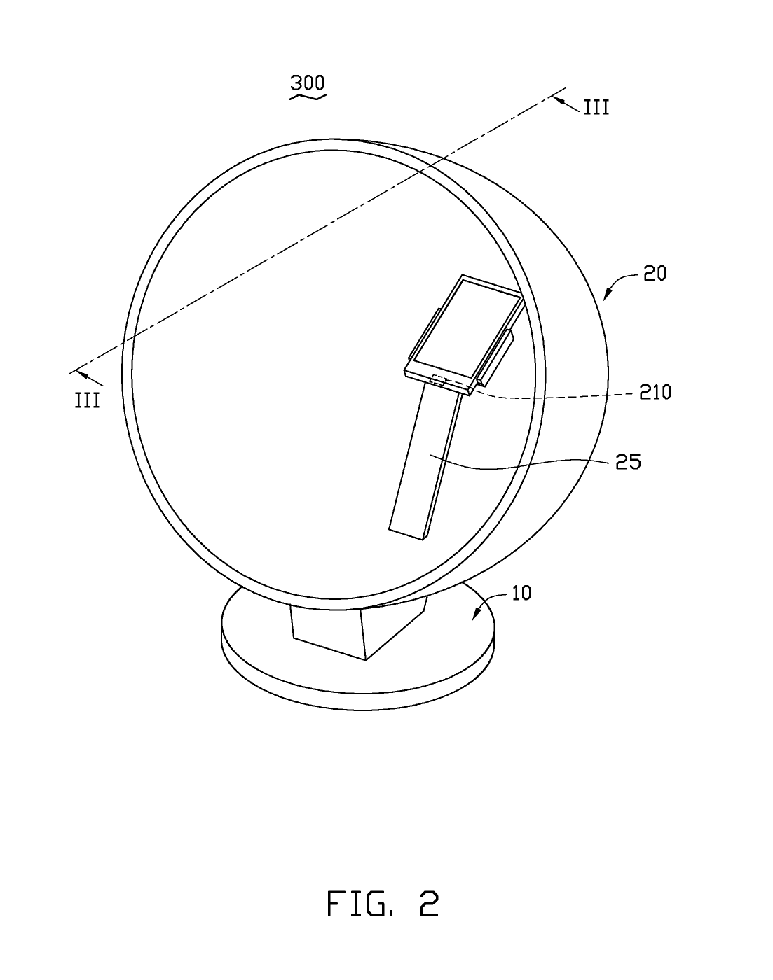

FIGS. 1 and 2 show an exemplary embodiment of a sound amplifying device 100 for amplifying a volume of an electronic device 200, such as a mobile phone, a digital camera, or MP3 players, for example. The electronic device 200 is removably mounted on the sound amplifying device 100.

The sound amplifying device 100 includes a base part 10 and an amplifying part 20 mounted on the base part 10.

The base part 10 includes a base plate 11 and a supporting member 12 formed on the base plate 11. In other embodiments, the supporting member 12 is rotatably mounted on the base plate 11 by a hinge pin, thus an angle formed between the amplifying part 20 and the base part 10 can be adjusted by rotating the supporting member 12.

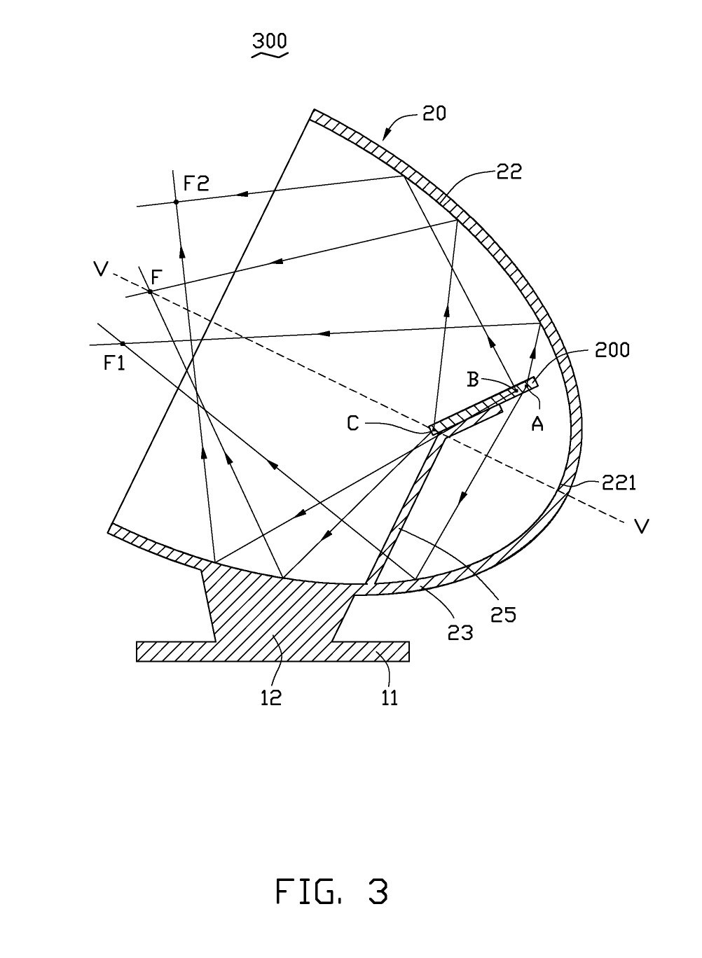

FIG. 3 shows that the amplifying part 20 is substantially a hood shape, and is made of materiel having a high sound reflective property. In the exemplary embodiment, the amplifying part 20 has a substantially semi-ellipse shape with a semi major axis and a minor axis, and includes an opening 21, a reflecting wall 22, an exterior surface 23 opposite to the reflecting wall 22, and a bracket 25 mounted on the reflecting wall 22.

The base part 10 connects to the exterior surface 23 of the amplifying part 20. The opening 21 is substantially coincident with the plane containing the minor axis of the reflecting wall 22. The opening 21 is inclined at an angle to the base part 10, which is good for sound transmission. The reflecting wall 22 has a hollow semi-ellipse shape with a semi major axis, and defines an arcuate end portion 221 corresponding to the opening 21. A central line V-V of the arcuate end portion 221 overlaps the semi major axis of the amplifying part 20.

In other exemplary embodiment, the reflecting wall 22 is coated with a film having a high sound reflective property.

The bracket 25 adjacent to the arcuate end portion 221 is mounted on one side of the reflecting wall 22 connecting to the base part 10. The bracket 25 is for removably supporting the electronic device 200. One end of the bracket 25 located on the central line V-V has a supporting base 251. In the exemplary embodiment, the supporting base 251 has a supporting surface 252 inclined toward to the opening 21. The supporting surface 252 has two clasp portions 253 located opposite to each other for supporting the electronic device 200.

In other embodiments, the supporting base 251 may be a suction cup, and the electronic device 200 can be suctioned securely.

In other exemplary embodiment, the supporting base 251 comprises a plurality of jaws, which can make more surfaces of the electronic device 200 be exposed to outside, to improve the emission of sound generated by loudspeaker 210 of the electronic device 200.

In use, the electronic device 200 is installed on the bracket 25. The electronic device 200 includes a portion A, a portion B and a portion C. The portion A and the portion B are located on the front side of the electronic device 200 and away from the major axis of the amplifying part 20. The portion C is located on the front side of the electronic device 200 and overlaps the major axis of the amplifying part 20. When the loudspeaker 210 is located at the portion A of the electronic device 200, sound emitted from the loudspeaker 210 is reflected by the reflecting wall 22, and then gathered at a rendezvous point F1 (see FIG. 3) which is outside of the opening 21. When the loudspeaker 210 is located on the portion B of the electronic device 200, the reflected sound will be assembled at a rendezvous point F2 (see FIG. 3), which is outside of the opening 21 as well. The formation of the rendezvous point F1 or F2 generates a maximum loudness effect.

In other exemplary embodiment, the loudspeaker 210 is located on the portion C, thus sound reflected by the reflecting wall 22 is more assembled at a rendezvous point F, which is located on the central line V-V. Therefore, the loud-amplifying effect of the sound amplifying device 100 will be even better.

The sound amplifying device 100 is small in size and does not require a power supply, which makes it convenient for travel.

FIG. 2 shows an electronic product 300 using the sound amplifying device 100. The electronic product 300 comprises the sound amplifying device 100 and an electronic device 200 removably mounted on the sound amplifying device 100.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A sound amplifying device comprising:
a base part; and
an amplifying part mounted on the base part, the amplifying part comprising a reflecting wall and a bracket, the reflecting wall having a hollow semi-ellipse shape with a semi major axis and a minor axis, the bracket being mounted on the reflecting wall and having one end locating on the semi major axis.

2. The sound amplifying device as claimed in claim 1, wherein the base part comprises a base plate and a supporting member formed on the base plate.

3. The sound amplifying device as claimed in claim 2, wherein the supporting member is rotatable mounted on the base plate.

4. The sound amplifying device as claimed in claim 1, wherein the amplifying part further comprises an opening, a reflecting wall, and an exterior surface opposite to the reflecting wall, the opening is substantially coincident with the plane containing the minor axis of the reflecting wall.

5. The sound amplifying device as claimed in claim 4, wherein the amplifying part further comprises a bracket mounted on the reflecting wall.

6. The sound amplifying device as claimed in claim 4, wherein the base part connects to the exterior surface of the amplifying part, the opening is inclined at an angle to the base part.

7. The sound amplifying device as claimed in claim 4, wherein the reflecting wall is coated with a film to enhance the loud-amplifying effect of the sound amplifying device.

8. The sound amplifying device as claimed in claim 4, wherein the reflecting wall comprises an arcuate end portion corresponding to the opening, central line of the arcuate end portion overlaps the semi major axis of the amplifying part.

9. The sound amplifying device as claimed in claim 8, wherein the bracket adjacent to the arcuate end portion is mounted on one side of the reflecting wall connecting to the base part.

10. The sound amplifying device as claimed in claim 8, wherein one end of the bracket located on the central line has a supporting base, the supporting base has a supporting surface inclined toward to the opening.

11. The sound amplifying device as claimed in claim 10, wherein the supporting surface has two clasp portions located opposite to each other for supporting portable electronic product.

12. The sound amplifying device as claimed in claim 10, wherein the supporting base is a suction cup.

13. The sound amplifying device as claimed in claim 10, wherein the supporting base comprises a plurality of jaws.

14. An electronic product, comprising:
a sound amplifying device comprising a base part and an amplifying part being mounted on the base part, the amplifying part comprising a reflecting wall and a bracket, the reflecting wall having a hollow semi-ellipse shape with a semi major axis and a minor axis, the bracket being mounted on the reflecting wall and having one end locating on the semi major axis; and
an electronic device removably mounted on the bracket.

15. The electronic product as claimed in claim 14, wherein the electronic device comprises a loudspeaker, the loudspeaker is located on the major axis of the amplifying part.

16. The electronic product as claimed in claim 14, wherein the amplifying part further comprises an opening, a reflecting wall, and an exterior surface opposite to the reflecting wall, the opening is substantially coincident with the plane containing the minor axis of the reflecting wall.

17. The electronic product as claimed in claim 16, wherein the amplifying part further comprises a bracket mounted on the reflecting wall.

18. The electronic product as claimed in claim 16, wherein the reflecting wall comprises an arcuate end portion corresponding to the opening, a central line of the arcuate end portion overlaps the semi major axis of the amplifying part.

19. The electronic product as claimed in claim 18, wherein the bracket adjacent to the arcuate end portion is mounted on one side of the reflecting wall connecting to the base part.

20. The electronic product as claimed in claim 18, wherein one end of the bracket located on the central line has a supporting base, the supporting base has a supporting surface inclined toward to the opening.
